(19) United States
(12) Patent Application Publication
(10) Pub. No.: US 2020/0396354 A1
(43) Pub. Date: Dec. 17, 2020

(54) TRANSMISSION DEVICE AND NON-TRANSITORY COMPUTER READABLE MEDIUM FOR FORWARDING ONLY A FINAL RESULT OF EACH TRANSMISSION JOB TO A SERVER

(71) Applicant: FUJI XEROX CO., LTD., Tokyo (JP)

(72) Inventor: Keitaro ISHIDA, Kanagawa (JP)

(73) Assignee: FUJI XEROX CO., LTD., Tokyo (JP)

(21) Appl. No.: 16/655,313

(22) Filed: Oct. 17, 2019

(30) Foreign Application Priority Data
Jun. 11, 2019 (JP) 2019-108740

(51) Int. Cl. H04N 1/32; H04N 1/00

(52) U.S. Cl. CPC H04N 1/32085; H04N 2201/0094; H04N 1/32406; H04N 1/00244

(57) ABSTRACT

A transmission device includes a controller that, in a case of transmitting a log of a transmission job to a server, controls forwarding such that each log remaining in the server is only a confirmed result for each transmission job.

### CROSS-REFERENCE TO RELATED APPLICATIONS

This application is based on and claims priority under 35 USC 119 from Japanese Patent Application No. 2019-108740 filed Jun. 11, 2019.

### BACKGROUND

### (i) Technical Field

The present disclosure relates to a transmission device and a non-transitory computer readable medium.

### (ii) Related Art

In offices, devices that combine the functions of a printer, an image scanner, and a facsimile machine into one piece of equipment are used. Devices of this type are called multi-function devices. Some multi-function devices are provided with a function of forwarding the content of executed jobs to a server as an image log. On the server, it is possible to check the saved image log. For example, the result of a facsimile transmission is recorded in part of the file name of the image log. See, for example, Japanese Unexamined Patent Application Publication No. 2015-204524.

### SUMMARY

For example, in the case in which a facsimile transmission fails, a log indicating the failure of the facsimile transmission is forwarded to the server. In this case, retransmission of the same document is executed automatically, and the result is also forwarded to the server. In the case in which the retransmission also fails, multiple logs indicating transmission failure related to the same document are recorded in the server. These records are equal to the number of times retransmission is executed until retransmission is successful. However, even if a record of transmission for the same document exists, the successful transmission is not necessarily the result of retransmission. For example, there is also a possibility that after canceling retransmission, the same document is transmitted again, and the result is successful.

Aspects of non-limiting embodiments of the present disclosure relate to leaving only the final result of each transmission job in the server.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transmission device including a controller that, in a case of transmitting a log of a transmission job to a server, controls forwarding such that each log remaining in the server is only a confirmed result for each transmission job.

### BRIEF DESCRIPTION OF THE DRAWINGS

Exemplary embodiments of the present disclosure will be described in detail based on the following figures, wherein:

FIG. 1 is a diagram explaining a conceptual configuration of an information processing system used in Exemplary Embodiment 1;

FIG. 2 is a diagram explaining an exemplary configuration of an image forming device used in Exemplary Embodiment 1;

FIG. 3 is a flowchart explaining an example of processing operations according to Exemplary Embodiment 1 executed in a case of forwarding a facsimile transmission result to a log server;

FIG. 4 is a diagram illustrating an example of a file name used in Exemplary Embodiment 1;

FIGS. 5A to 5C are diagrams explaining an example of log storage in Exemplary Embodiment 1, in which FIG. 5A illustrates an example of a case in which a first facsimile transmission fails, FIG. 5B illustrates an example of a case in which a second facsimile transmission fails, and FIG. 5C illustrates an example of a case in which a third facsimile transmission succeeds;

FIGS. 6A to 6D are diagrams explaining another example of log storage in Exemplary Embodiment 1, in which FIG. 6A illustrates an example of a case in which a first facsimile transmission fails, FIG. 6B illustrates an example of a case in which a second facsimile transmission fails, FIG. 6C illustrates cancellation of the transmission job, and FIG. 6D illustrates an example of a case in which facsimile transmission succeeds by a different transmission job of the same document to the same destination;

FIGS. 7A to 7D are diagrams explaining a comparative example, in which FIG. 7A illustrates an example of a case in which a first facsimile transmission fails, FIG. 7B illustrates an example of a case in which a second facsimile transmission fails, FIG. 7C illustrates cancellation of the transmission job, and FIG. 7D illustrates an example of a case in which facsimile transmission succeeds by a different transmission job of the same document to the same destination;

FIG. 8 is a flowchart explaining an example of processing operations according to Exemplary Embodiment 2 executed in a case of forwarding a facsimile transmission result to a log server;

FIGS. 9A to 9D are diagrams explaining an example of log storage in Exemplary Embodiment 2, in which FIG. 9A illustrates an example of a case in which a first facsimile transmission fails, FIG. 9B illustrates an example of a case in which a second facsimile transmission fails, FIG. 9C illustrates an example of a case in which a third facsimile transmission succeeds, and FIG. 9D illustrates an example of a case in which failure of the transmission job is confirmed after retrying twice;

FIGS. 10A and 10B are diagrams explaining another example of log storage in Exemplary Embodiment 2, in which FIG. 10A illustrates an example of a case in which failure of the transmission job is confirmed after retrying twice, and FIG. 10B illustrates an example of a case in which facsimile transmission succeeds by a different transmission job of the same document to the same destination;

FIG. 11 is a diagram explaining a conceptual configuration of an information processing system used in Exemplary Embodiment 3;

FIG. 12 is a flowchart explaining an example of processing operations according to Exemplary Embodiment 3 executed in a case of forwarding a facsimile transmission result to a log server;

FIG. 13 is a diagram illustrating an example of a file name used in Exemplary Embodiment 3;

FIG. 14 is a diagram explaining an example of log storage in Exemplary Embodiment 3;

FIG. 15 is a diagram explaining a conceptual configuration of an information processing system used in Exemplary Embodiment 4;

FIG. 16 is a flowchart explaining an example of processing operations according to Exemplary Embodiment 4 executed in a case of forwarding a facsimile transmission result to a log server; and

FIGS. 17A to 17C are diagrams explaining an example of log storage in Exemplary Embodiment 4, in which FIG. 17A illustrates an example of a case in which a first facsimile transmission fails, FIG. 17B illustrates an example of a case in which a second facsimile transmission fails, and FIG. 17C illustrates an example of a case in which a third facsimile transmission succeeds.

### DETAILED DESCRIPTION

Hereinafter, exemplary embodiments of the disclosure will be described with reference to the drawings.

### Exemplary Embodiment 1

### <Overall Configuration of System>

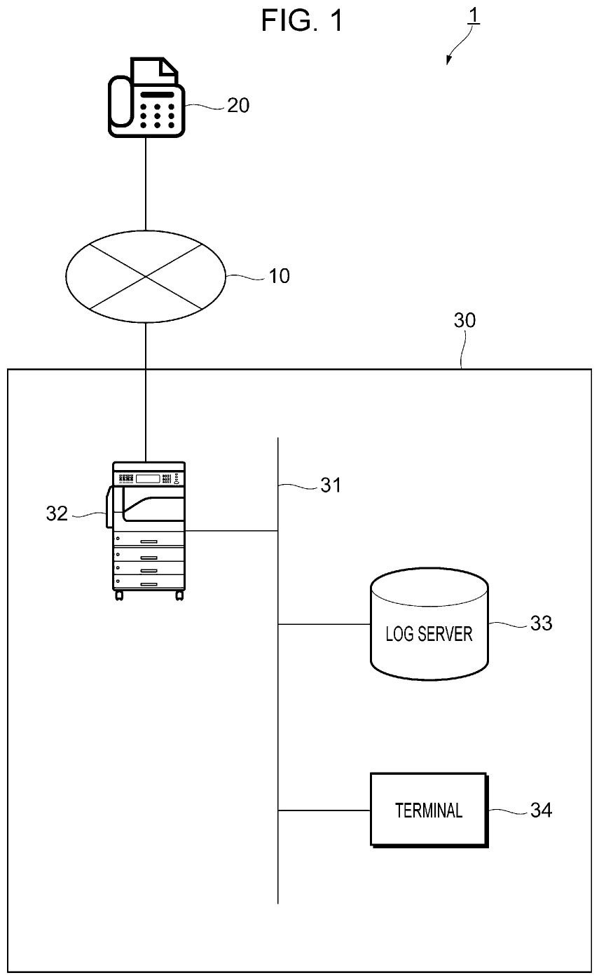

FIG. 1 is a diagram explaining a conceptual configuration of an information processing system 1 used in Exemplary Embodiment 1. The information processing system 1 illustrated in FIG. 1 includes a public network 10, a facsimile machine 20 connected to the public network 10, and a business system 30. Obviously, the device connected to the business system 30 through the public network 10 is not limited to the facsimile machine 20, insofar as the device includes facsimile functions.

The business system 30 includes a local area network 31, an image forming device 32 that includes facsimile functions, a log server 33 specified as the forwarding destination of logs indicating the results of facsimile transmissions, and a terminal 34 operated by an administrator or a worker. Although diagram illustrates one each of the image forming device 32 and the terminal 34, multiple image forming devices 32 and multiple terminals 34 may also exist. In the case of the present exemplary embodiment, an administrator refers to a worker who has been given special rights to access functions involved in the maintenance and management of the image forming device 32. As illustrated in FIG. 1, the image forming device 32, the log server 33, and the terminal 34 are interconnected through the local area network 31. The log server 33 is one example of a server. In the case of FIG. 1, the log server 33 exists on the same local area network 31 as the image forming device 32, but the log server 33 may also exist on the Internet or on a cloud network.

### <Configuration of Image Forming Device>

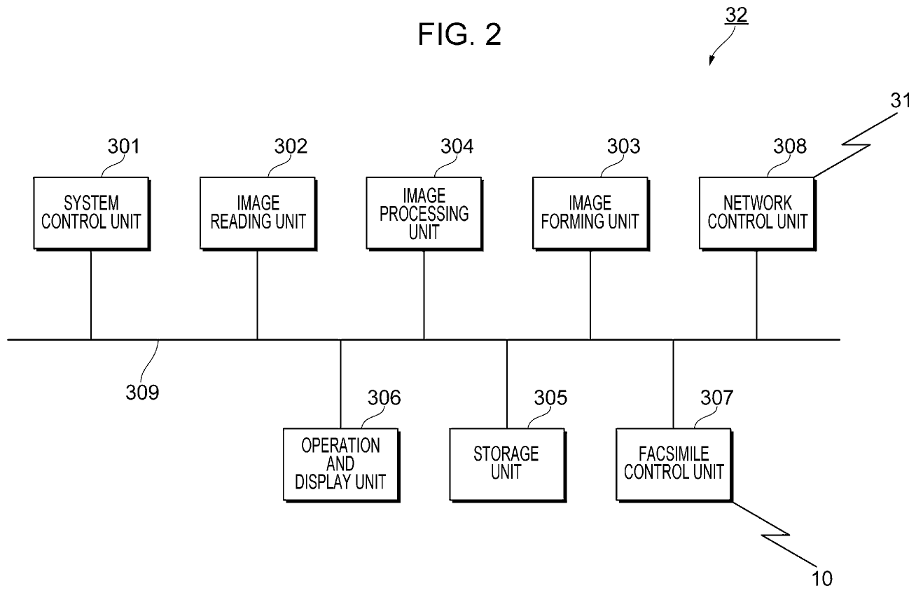

FIG. 2 is a diagram explaining an exemplary configuration of the image forming device 32 used in Exemplary Embodiment 1. The image forming device 32 illustrated in FIG. 2 includes a system control unit 301 that controls the system overall, an image reading unit 302 that reads an image representing a document, an image forming unit 303 that forms an image on a sheet of paper, which is one example of a recording medium, an image processing unit 304 that applies processing such as color correction and tone correction to an image expressed by image data, a storage unit 305 that stores information such as image data, an operation and display unit 306 used to receive operations performed by a worker and display information, a facsimile control unit 307 that controls facsimile communication, and a network control unit 308 that controls network communication. In other words, the image forming device 32 in Exemplary Embodiment 1 is provided with multiple functions, including a function of reading an image representing a document, a function of forming an image on a sheet of paper, and a function of controlling facsimile communication. The image forming device 32 according to the present exemplary embodiment is one example of a transmission device. Note that the units included in the image forming device 32 are connected through a bus 309 and signal lines not illustrated.

The system control unit 301 includes a central processing unit (CPU), read-only memory (ROM) storing data such as firmware and a basic input-output system (BIOS), random access memory (RAM) that is used as a work area, and the like. The system control unit 301 is also referred to as a computer, and provides various function through the execution of one or more programs. The system control unit 301 according to the present exemplary embodiment also provides a function of forwarding a log including a result of executing a transmission job for example to the log server 33 (see FIG. 1). The system control unit 301 herein is one example of a controller.

The image reading unit 302 is a device used to read a document to make a copy of the document or transmit a facsimile, and is also called a scanner. The image reading unit 302 according to the present exemplary embodiment is also equipped with a device that automatically conveys a document. The image forming unit 303 is a device that forms an image on a sheet of paper, which is one example of a recording medium, according to an electrophotographic system, an inkjet method, or the like. The image forming unit 303 also includes a device that conveys sheets of paper. The image processing unit 304 includes a dedicated processor, processing circuit, or the like for processing image data into data suited to printing. The storage unit 305 is a non-volatile storage device, and includes a hard disk drive (HDD) for example. The storage unit 305 saves data such as image data corresponding to an image representing a document read by the image reading unit 302, image data supplied externally by communication, and image data transmitted or received through facsimile communication.

The operation and display unit 306 includes switches and buttons arranged on an operation panel or the like, a liquid crystal display or an organic electroluminescence (EL) display used to the display information, a touch sensor that detects operations by a worker on the display screen, and the like. The facsimile control unit 307 controls the execution of transmission jobs and the execution of reception jobs related to facsimile communication, while also controlling the storage of logs containing the execution results in the storage unit 305. The network control unit 308 controls communication with the log server (see FIG. 1) and the terminal 34 (see FIG. 1) via the local area network 31 (see FIG. 1).

### <Example of Processing Operations>

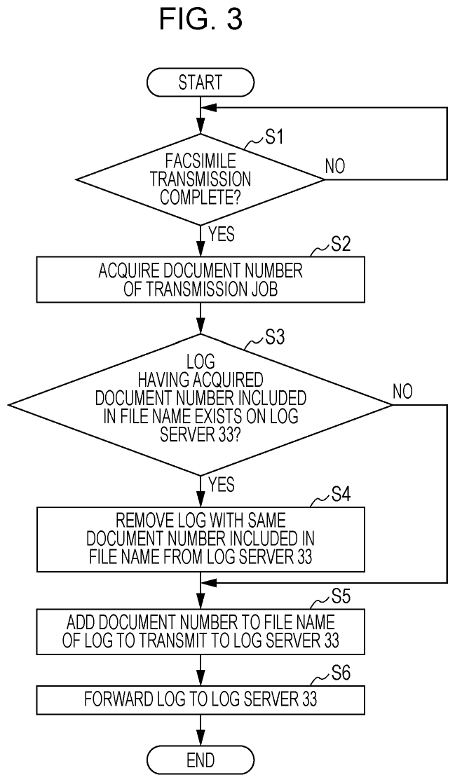

FIG. 3 is a flowchart explaining an example of processing operations according to Exemplary Embodiment 1 executed in a case of forwarding a facsimile transmission result to the log server 33 (see FIG. 1). The processing operations illustrated in FIG. 3 are achieved by the system control unit 301 (see FIG. 2) executing a program. Note that the symbol “S” in the diagram means “step”. Note that the functions illustrated in FIG. 3 are executed in a case in which a function of forwarding an image file of a document transmitted by the facsimile control unit 307 (see FIG. 2) via the public network 10 (see FIG. 1) to the log server 33 (see FIG. 1) is enabled. Consequently, in the case where this function is disabled, the processing operations illustrated in FIG. 3 are not executed. In the following, an image file to be forwarded is referred to as a log.

When a transmission job is launched by receiving an operation by a worker or the like, the system control unit 301 determines whether or not facsimile transmission is complete (step 1). The system control unit 301 repeats the determination while is negative result is obtained in step 1. Herein, “complete” means the end of a single execution of a facsimile transmission to a communication partner. Consequently, a “complete” facsimile transmission is one of two types: a successful transmission or a failed transmission. In the case in which the facsimile transmission fails, the system control unit 301 puts the transmission job in a standby state. On the other hand, in the case in which the facsimile transmission succeeds or the transmission job is canceled, the system control unit 301 removes the transmission job.

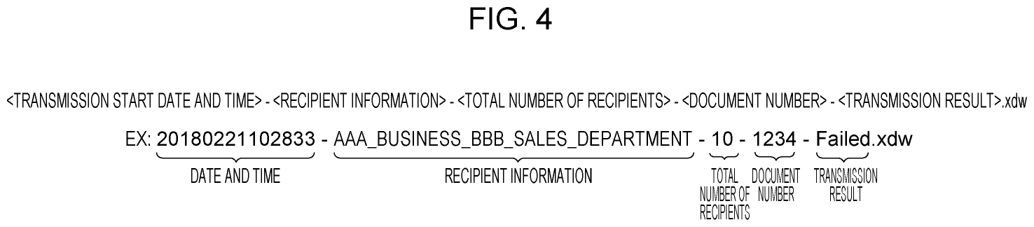

When a positive result is obtained in step 1, the system control unit 301 acquires a document number of the transmission job (step 2). The document number is a number identifying the document, and is assigned to every transmission job. The document number is one example of information for managing the document. Document numbers are managed in each image forming device 32 (see FIG. 1). FIG. 4 is a diagram illustrating an example of a file name used in Exemplary Embodiment 1. As illustrated in FIG. 4, the file name includes the transmission start date and time, recipient information, the total number of recipients, the document number, and the transmission result. Note that “xdw” is the extension.

Note that a start time is recorded in the transmission start date and time every time the facsimile transmission is executed. Information specifying the recipient of the facsimile transmission is recorded in the recipient information. The total number of recipients of the facsimile transmission is recorded in the total number of recipients. The result of the facsimile transmission is recorded in the transmission result every time the facsimile transmission is executed. The above information is recorded as text. In FIG. 4, a character string indicating 10:28:33 on Feb. 21, 2018 is illustrated as a specific example of the transmission start date and time. Also, “AAA Business BBB Sales Department” is illustrated as a specific example of the recipient information, and “10” is illustrated as a specific example of the total number of recipients. Also, “1234” is illustrated as a specific example of the document number. Furthermore, “Failed” which indicates failure is illustrated as a specific example of the transmission result. In other words, the specific example illustrated in FIG. 4 illustrates that the transmission of a facsimile to the communication partner has failed. On the other hand, in the case in which the transmission result is successful, “succeeded” is recorded for example.

The description will now return to FIG. 3. When the document number is acquired in step 2, the system control unit 301 determines whether or not a log having the acquired document number included in the file name exists in the log server 33 (step 3). In the case in which a positive result is obtained in step 3, the system control unit 301 removes the log having the same document number included in the file name from the log server 33 (step 4). In other words, the system control unit 301 removes, from the log server 33, the log whose file name contains the same document number as the log that is scheduled to be newly forwarded to the log server 33. After step 4, or in the case in which a negative result is obtained in step 3, the system control unit 301 adds the document number to the file name of the log to transmit to the log server 33 (step 5), and after that, forwards the log to the log server 33 (step 6). At this point, the case in which a negative result is obtained in step 3 means that a log with the same document number included in the file name does not exist in the log server 33. In other words, this is the case in which the facsimile transmission is the first transmission attempt.

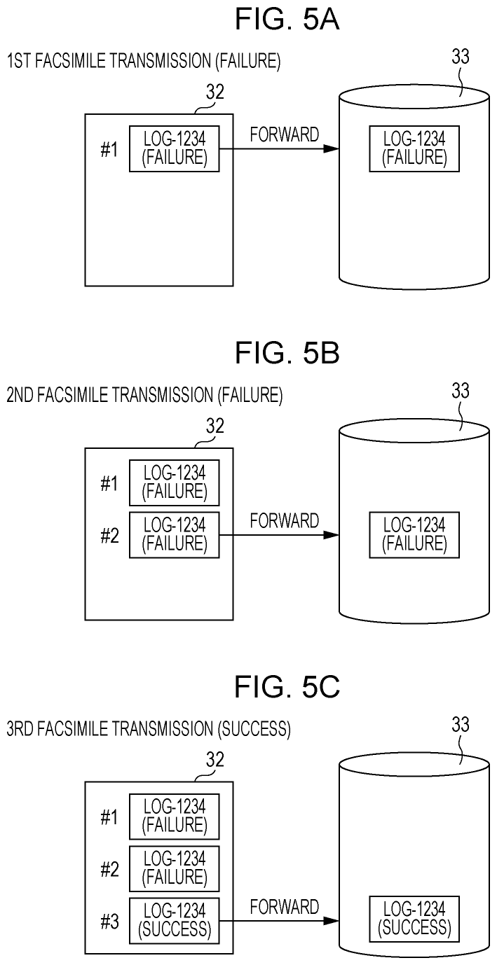

FIGS. 5A to 5C are diagrams explaining an example of log storage in Exemplary Embodiment 1, in which FIG. 5A illustrates an example of a case in which a first facsimile transmission fails, FIG. 5B illustrates an example of a case in which a second facsimile transmission fails, and FIG. 5C illustrates an example of a case in which a third facsimile transmission succeeds. Herein, it is assumed that before the first facsimile transmission is started, a log with the document number “1234” in the file name is not being stored in the log server 33. In the case in which the first facsimile transmission of the document managed under the document number “1234” fails, a log whose file name includes information indicating the transmission failure is forwarded from the image forming device 32 to the log server 33 and stored.

In the case in which the first facsimile transmission fails, the transmission job by the image forming device 32 is put into a standby state. When a predetermined amount of time elapses, the image forming device 32 re-executes the transmission job. For example, the same transmission job is re-executed 30 seconds after the completion of the first facsimile transmission. Because the transmission job is the same, the document number is unchanged. In the example of FIG. 5B, the second facsimile transmission of the document managed under the document number “1234” also fails. In the case in which the second facsimile transmission of the same transmission job also fails, the image forming device 32 removes the log corresponding to the first facsimile transmission from the log server 33, and after that, stores a log corresponding to the second facsimile transmission in the log server 33. This operation is executed as an overwrite of the log. In the case in which the second facsimile transmission also fails, the image forming device 32 waits for a predetermined amount of time to elapse and then re-executes the same transmission job. In the example of FIG. 5C, a third facsimile transmission of the document managed under the document number “1234” is executed.

In the case of FIG. 5C, the third facsimile transmission succeeds. For this reason, the image forming device 32 removes the log corresponding to the second facsimile transmission stored in the log server 33, and after that, stores a log corresponding to the third facsimile transmission in the log server 33. In other words, a log whose file name includes information indicating a failed transmission result is removed, and a log whose file name includes information indicating a successful transmission result is stored in the log server 33. As a result, in the log server 33, one log is managed for one document number. Moreover, because the storage of a log is executed as an overwrite, only the chronologically most recent or last log for a single document number remains in the log server 33. For this reason, the worker or the like who operates the terminal 34 (see FIG. 1) knows that the execution of the transmission job managed under the document number “1234” ultimately succeeded.

In the case of the present exemplary embodiment, only a single log is stored in the log server 33, whether in the case in which the first facsimile transmission succeeds, the case in which the second facsimile transmission succeeds, or in the case in which the fourth or subsequent facsimile transmission succeeds. Note that a log that the image forming device 32 forwards to the log server 33 is one example of a first log, while a log inside the log server 33 whose file name includes the same document number as the forwarded log is one example of a second log.

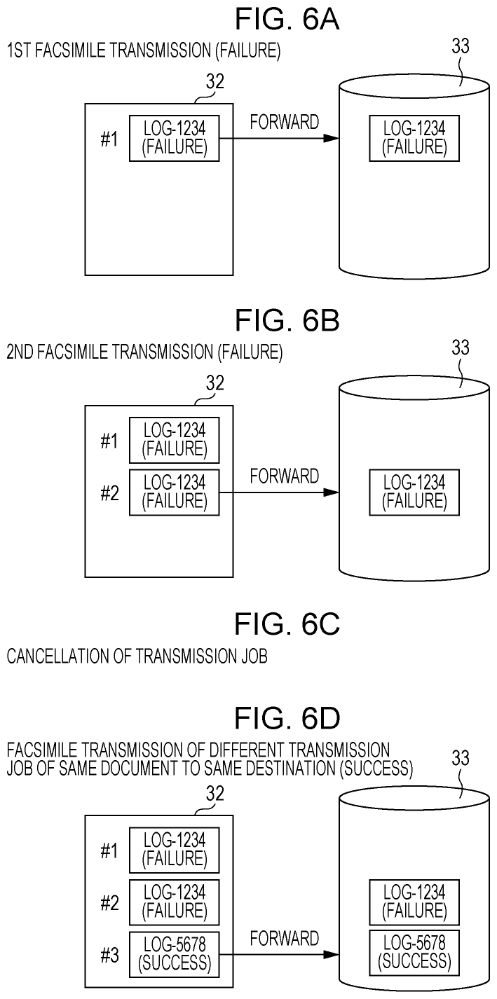

FIGS. 6A to 6D are diagrams explaining another example of log storage in Exemplary Embodiment 1, in which FIG. 6A illustrates an example of a case in which a first facsimile transmission fails, FIG. 6B illustrates an example of a case in which a second facsimile transmission fails, FIG. 6C illustrates cancellation of the transmission job, and FIG. 6D illustrates an example of a case in which facsimile transmission succeeds by a different transmission job of the same document to the same destination. In this case, it is likewise assumed that before the first facsimile transmission is started, a log with the document number “1234” in the file name is not being stored in the log server 33.

In the case of FIG. 6B, at the point in time when the second facsimile transmission fails, the content of the log stored in the log server 33 is the same as FIG. 5B. In other words, the log indicating the result of the first facsimile transmission is overwritten by the log indicating the result of the second facsimile transmission. In the example of FIG. 6C, the worker or the like who has learned that the facsimile transmission has failed twice in a row decides to cancel the transmission job, and after that, gives an instruction to transmit a facsimile of the same document to the same destination. In the case of FIG. 6D, even if transmitting a facsimile of the same document to the same destination, the image forming device 32 manages the facsimile transmission as a different transmission job. For this reason, the image forming device 32 uses a document number different from that of the canceled transmission job as the document number used to manage the new transmission job. In the example of FIG. 6D, “5678” is used as the document number.

In this case, a log with the document number “5678” is not being stored in the log server 33. For this reason, the log with the document number “1234” included in the file name is not removed from the log server 33. Also, a log with the document number “5678” included in the file name is newly added to the log server 33. In the case of FIG. 6D, because the facsimile transmission managed under the document number “5678” succeeds, a log with “5678” recorded as the document number and “succeeded” recorded as the transmission result in the file name is stored in the log server 33. Note that in the case of FIG. 6D, the facsimile transmission managed under the document number “1234” is stored as having ultimately ended in failure in the log server 33. At this point, the log with the document number “1234” in the file name and the log with the document number “5678” in the file name have the same recipient, and furthermore have the same content of the image file, the worker or the like knows that the initial transmission job ended in failure.

### Comparative Example

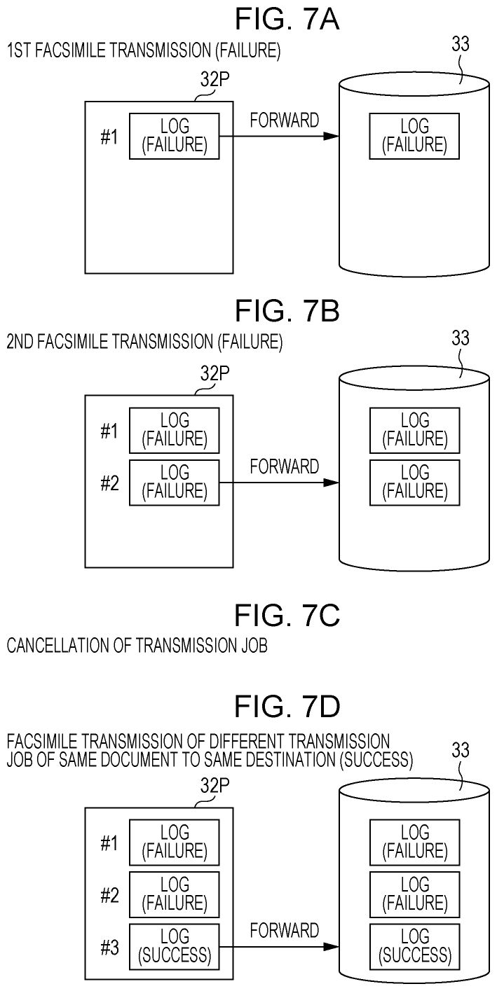

For reference, a case will be described in which the processing operations illustrated in the present exemplary embodiment are not adopted, and differences between transmission jobs are not distinguishable from the information in logs stored in the log server 33. FIGS. 7A to 7D are diagrams explaining a comparative example, in which FIG. 7A illustrates an example of a case in which a first facsimile transmission fails, FIG. 7B illustrates an example of a case in which a second facsimile transmission fails, FIG. 7C illustrates cancellation of the transmission job, and FIG. 7D illustrates an example of a case in which facsimile transmission succeeds by a different transmission job of the same document to the same destination. The comparative example illustrated in FIGS. 7A to 7D is a case in which logs do not have the document number included in the file name, or even if the document number is included in the file name, the document number is not used to determined whether to forward a log to the log server 33.

In the comparative example illustrated in FIGS. 7A to 7D, the reference sign 32P will be used to distinguish this image forming device from the image forming device 32 (see FIG. 1) having the functions described above. Because the image forming device 32P does not use the document number to determine whether to forward a log, a newly generated log is additionally stored in the log server 33, even if a log corresponding to the same transmission job exists in the log server 33. For this reason, in the comparative example illustrated in FIG. 7B, at the point in time when the facsimile transmission has failed twice in a row, two logs corresponding to the same transmission job are stored in the log server 33. In FIG. 7C, the failed transmission job likewise is canceled, and after that, an instruction is given to transmit a facsimile of the same document to the same destination. Also, in the case of FIG. 7D, the facsimile transmission by the different transmission job also succeeds.

In this case, two logs whose file names include a transmission result indicating facsimile transmission failure and one log whose file name includes a transmission result indicating facsimile transmission success are stored in the log server 33. The file names of these three logs all have the same content except for the transmission start date and time, and the body of the logs, namely the content of the image file, is also the same. For this reason, a worker or the like is unable to distinguish whether the logs stored in the log server 33 correspond to the same transmission job or to different transmission jobs.

### Exemplary Embodiment 2

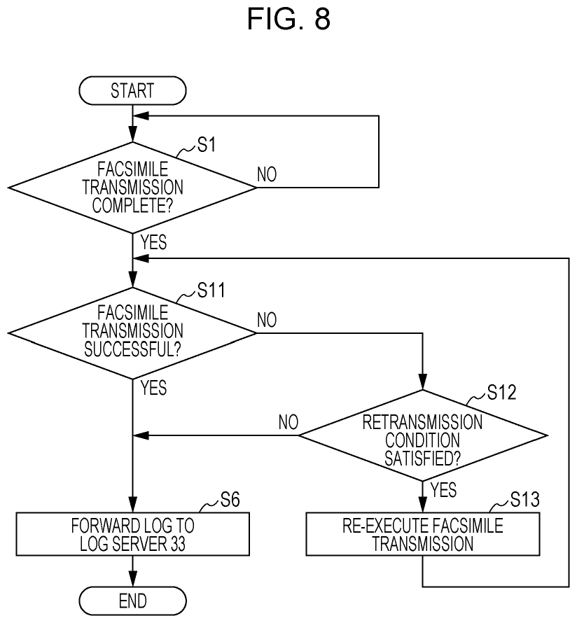

Next, Exemplary Embodiment 2 will be described. The present exemplary embodiment also presupposes the information processing system 1 illustrated in FIG. 1. However, in the case of the present exemplary embodiment, the result of a transmission job is forwarded and transmitted to the log server 33 according to a different method from Exemplary Embodiment 1. FIG. 8 is a flowchart explaining an example of processing operations according to Exemplary Embodiment 2 executed in a case of forwarding a facsimile transmission result to the log server 33. In FIG. 8, portions that correspond to FIG. 3 are denoted with the same signs.

The processing operations illustrated in FIG. 8 are likewise achieved by the system control unit 301 (see FIG. 2) executing a program. Note that the symbol “S” in the diagram means “step”. Note that the functions illustrated in FIG. 8 are executed in a case in which a function of forwarding an image file of a document transmitted by the facsimile control unit 307 (see FIG. 2) via the public network 10 (see FIG. 1) to the log server 33 is enabled. Consequently, in the case where this function is disabled, the processing operations illustrated in FIG. 8 are not executed. When a transmission job is launched, the system control unit 301 determines whether or not facsimile transmission is complete (step 1). The system control unit 301 repeats the determination while is negative result is obtained in step 1. As described earlier, “complete” means the end of a single execution of a facsimile transmission to a communication partner.

When a positive result is obtained in step 1, the system control unit 301 determines whether or not the facsimile transmission was successful (step 11). In the case in which a positive result is obtained in step 11, the system control unit 301 forwards a log to the log server 33 (step 6). In other words, the system control unit 301 forwards a log to the log server 33 by assigning a file name to the image file of the document transmitted by facsimile. However, in the case of the present exemplary embodiment, whether or not the document number is included in the file number is optional. Consequently, the document number may be included in the file name, but the document number does not have to be included. As described later, this is because in the present exemplary embodiment, one log is kept for one transmission job in the log server 33.

In the case in which a negative result is obtained in step 11, the system control unit 301 determines whether or not a retransmission condition is satisfied (step 12). The retransmission condition in the present exemplary embodiment is that, for example, the retry count does not exceed a predetermined upper limit, and that a worker or the like has not canceled the transmission job before the retry count reaches the upper limit. The upper limit on the retry count is two times, for example. Note that for the upper limit on the retry count, an initial value may be used, or a value set by a worker or the like may be used. In the case in which a positive result is obtained in step 12, the system control unit 301 re-executes facsimile transmission (step 13), and returns to step 11 described above. In other words, the case of obtaining a positive result in step 12 is equivalent to the case in which there is still a possibility that retransmission will be executed. Returning to step 11, the system control unit 301 again determines whether or not the facsimile transmission was successful.

On the other hand, in the case in which a negative result is obtained in step 12, the system control unit 301 proceeds to step 6 without executing retransmission of the document. In other words, the case in which a negative result is obtained in step 12 means that there is no longer a possibility that retransmission will be executed. For this reason, the system control unit 301 automatically removes the transmission job. Note that the system control unit 301 proceeding to step 6 transmits a log indicating a failed communication result to the log server 33. As described above, in the case of the present exemplary embodiment, a log is transmitted to the log server 33 either in the case in which facsimile transmission succeeds or in the case in which facsimile transmission fails until the retransmission condition is no longer satisfied. For this reason, only one log is stored in the log server 33 for one transmission job.

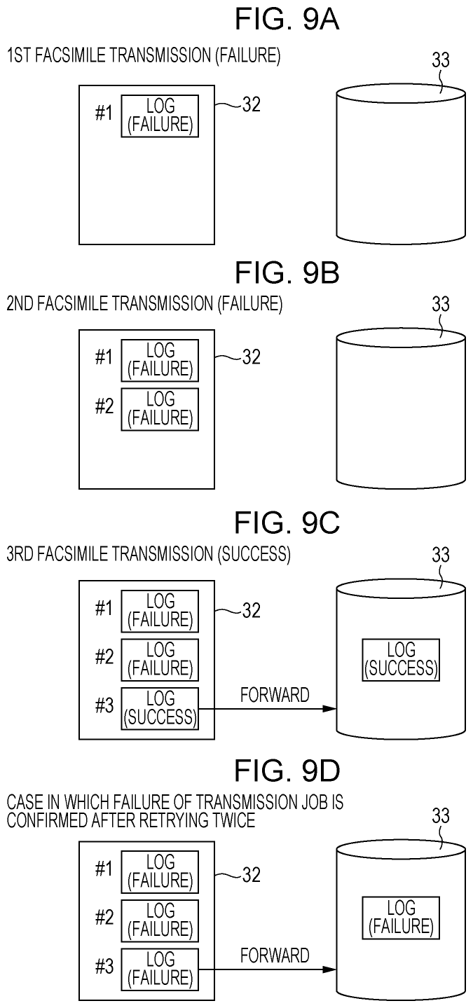

FIGS. 9A to 9D are diagrams explaining an example of log storage in Exemplary Embodiment 2, in which FIG. 9A illustrates an example of a case in which a first facsimile transmission fails, FIG. 9B illustrates an example of a case in which a second facsimile transmission fails, FIG. 9C illustrates an example of a case in which a third facsimile transmission succeeds, and FIG. 9D illustrates an example of a case in which failure of the transmission job is confirmed after retrying twice. As illustrated in FIG. 9A, even in the case in which the first facsimile transmission of the document based on the launched transmission job fails, in the present exemplary embodiment, a log is not forwarded to the log server 33. For this reason, a log corresponding to the transmission job currently being executed is not stored in the log server 33.

The transmission job for which the first facsimile transmission has failed is put into a standby state by the system control unit 301. When a predetermined amount of time elapses, the system control unit 301 determines whether or not the retransmission condition is satisfied. In the case of the present exemplary embodiment, the upper limit on the retry count is two times. For this reason, the system control unit 301 re-executes facsimile transmission. In the case of FIG. 9B, the second facsimile transmission also fails. In this case, when the predetermined amount of time elapses, the system control unit 301 likewise determines whether or not the retransmission condition is satisfied. Herein, the retry count is two times. For this reason, the system control unit 301 re-executes facsimile transmission. By this re-execution of facsimile transmission, the retry count reaches the upper limit.

In the case in which the second retransmission, or in other words the third facsimile transmission counting from the initial transmission, succeeds, the system control unit 301 forwards a log indicating that the facsimile transmission by the transmission job ended successfully to the log server 33. This case corresponds to FIG. 9C. In the case of the present exemplary embodiment, logs indicating that the first and second facsimile transmissions failed are not stored in the log server 33. On the other hand, in the case in which the second retransmission also fails, because the retry count has already reached the upper limit, another retry of the facsimile transmission is not performed, and the transmission job itself is removed. In this case, the facsimile transmission by the transmission job is confirmed to be a failure. For this reason, the system control unit 301 forwards a log indicating that the facsimile transmission by the transmission job ended in failure to the log server 33. This case corresponds to FIG. 9D.

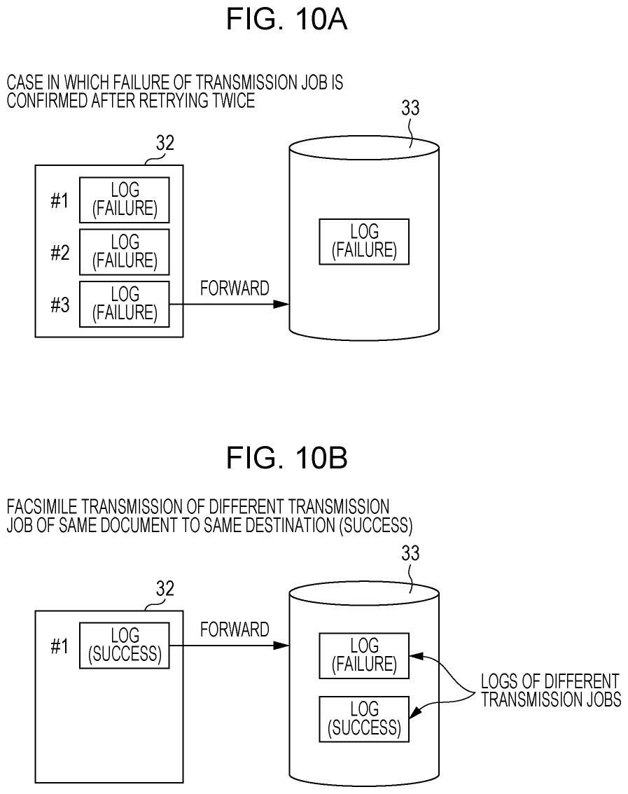

FIGS. 10A and 10B are diagrams explaining another example of log storage in Exemplary Embodiment 2, in which FIG. 10A illustrates an example of a case in which failure of the transmission job is confirmed after retrying twice, and FIG. 10B illustrates an example of a case in which facsimile transmission succeeds by a different transmission job of the same document to the same destination. The example illustrated in FIG. 10A is the same as the example in FIG. 9D. For this reason, a log indicating that the facsimile transmission by the transmission job ended in failure is stored in the log server 33. In this case, a different transmission job for transmitting the same document to the same destination may be launched. For example, if a worker or the like instructs the image forming device 32 (see FIG. 1) to transmit a facsimile of the same document, a different transmission job is launched.

In FIG. 10B, the facsimile transmission by the different transmission job succeeds. For this reason, a log indicating that the facsimile transmission was successful is stored in the log server 33. In this case, even though the file names of the two logs stored in the log server 33 are the same except for the transmission start date and time, and furthermore the body of the logs, namely the content of the image file, is also the same, the two logs are understood to correspond to different transmission jobs. For this reason, if two logs exist, the worker or the like is able to understand that the first transmission job failed while the second transmission job succeeded.

### Exemplary Embodiment 3

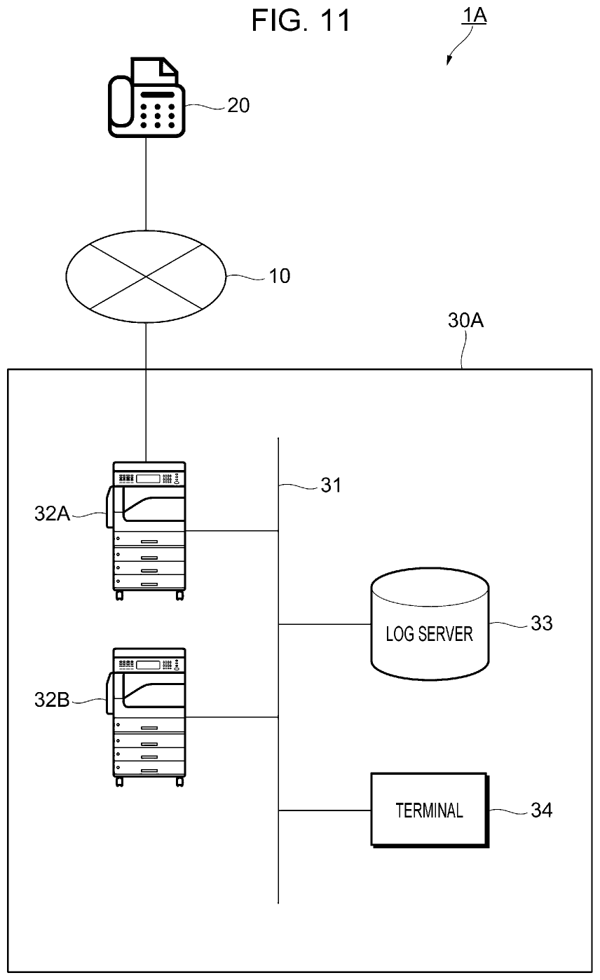

Next, Exemplary Embodiment 3 will be described. FIG. 11 is a diagram explaining a conceptual configuration of an information processing system 1A used in Exemplary Embodiment 3. In FIG. 11, portions that correspond to FIG. 1 are denoted with the same signs. Exemplary Embodiment 3 differs from Exemplary Embodiment 1 in that image forming devices 32A and 32B exist in a business system 30A. In the case of Exemplary Embodiment 1, the image forming device 32 (see FIG. 1) manages a document number for every transmission job. In other words, the management of document numbers in the image forming device 32 is independent for each device. For this reason, a situation could occur in which a document number assigned by the image forming device 32A and a document number assigned by the image forming device 32B overlap.

In the case of applying the method described in Exemplary Embodiment 1 to the multiple image forming devices 32A and 32B, and managing the transmission results of respective transmission jobs in a single log server 33, a situation could occur in which a log forwarded by the image forming device 32A and stored in the log server 33 is overwritten by a log forwarded to the log server 33 by the image forming device 32B. In such a case, it may become difficult to understand from the logs stored in the log server 33 whether the facsimile transmission by the transmission job executed by the image forming device 32A ultimately succeeded or failed. Accordingly, in the present exemplary embodiment, a device serial number is included in the file name, and when a log is forwarded to the log server 33, a method is adopted in which an old log is allowed to be overwritten by a new log on the condition that both the serial number and the document number are the same. Note that if either one of the serial number and the document number is different, the logs are understood to be logs of different transmission jobs, and therefore the old log is not overwritten by the new log.

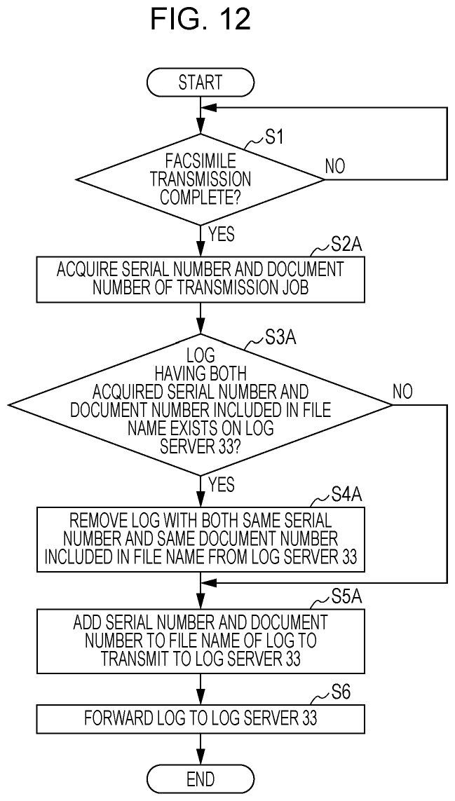

FIG. 12 is a flowchart explaining an example of processing operations according to Exemplary Embodiment 3 executed in a case of forwarding a facsimile transmission result to the log server 33. In FIG. 12, portions that correspond to FIG. 3 are denoted with the same signs. Note that the symbol “S” in the diagram means “step”. Incidentally, the processing operations illustrated in FIG. 12 are executed independently by the system control unit 301 (see FIG. 2) included in each of the image forming devices 32A (see FIGS. 11) and 32B (see FIG. 11). When a transmission job is launched by receiving an operation by a worker or the like, the system control unit 301 determines whether or not facsimile transmission is complete (step 1). The system control unit 301 repeats the determination while is negative result is obtained in step 1.

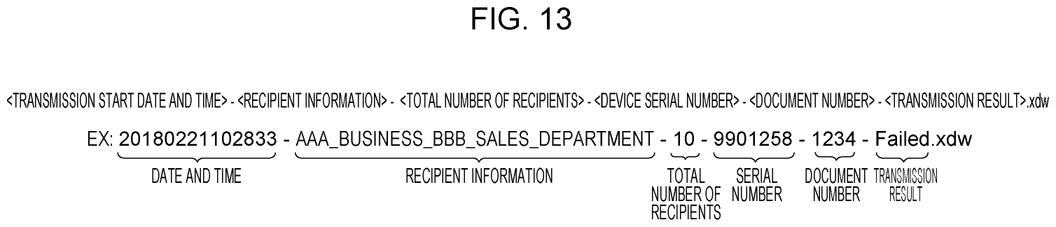

When a positive result is obtained in step 1, the system control unit 301 acquires the serial number and the document number of the transmission job (step 2A). The serial number is a number that allows a device to be uniquely specified, such as a manufacturing number or an individual identification number of the image forming device 32A or 32B (see FIG. 11). The serial number is one example of information indicating the origin of the log. FIG. 13 is a diagram illustrating an example of a file name used in Exemplary Embodiment 3. In FIG. 13, portions that correspond to FIG. 4 are denoted with the same signs. In the case of FIG. 13, the device serial number is added at the position between the total number of recipients and the document number. In the case of FIG. 13, “9901258” is illustrated as a specific example of the device serial number.

Returning to the description of FIG. 12, when the serial number and the document number is acquired in step 2A, the system control unit 301 determines whether or not a log having both the acquired serial number and the acquired document number included in the file name exists in the log server 33 (step 3A). In the case in which a positive result is obtained in step 3A, the system control unit 301 removes the log having both the same serial number and the same document number included in the file name from the log server 33 (step 4A). In other words, the system control unit 301 removes, from the log server 33, the log whose file name contains both the same serial number and the same document number as the log that is scheduled to be newly forwarded to the log server 33.

After step 4A, or in the case in which a negative result is obtained in step 3A, the system control unit 301 adds the serial number and the document number to the file name of the log to transmit to the log server 33 (step 5A), and after that, forwards the log to the log server 33 (step 6). At this point, the case in which a negative result is obtained in step 3A means that a log with the same serial number and the same document number included in the file name does not exist in the log server 33.

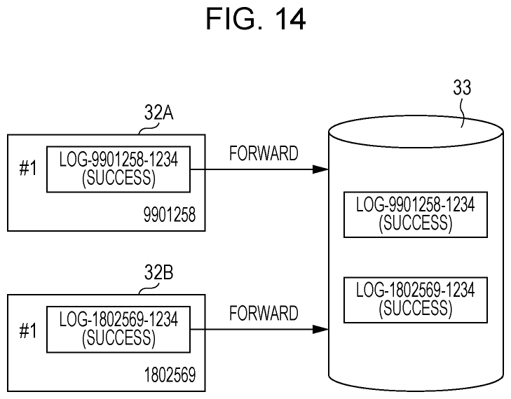

FIG. 14 is a diagram explaining an example of log storage in Exemplary Embodiment 3. In the case of FIG. 14, the serial number of the image forming device 32A is “9901258”, and the serial number of the image forming device 32B is “1802569”. Note that in the case of FIG. 14, the document number is “1234” in both the image forming device 32A and the image forming device 32B. In the case of Exemplary Embodiment 1, because only the document number is used to determine the difference between transmission jobs, one log could be overwritten by the other log, but in the case of the present exemplary embodiment, a log is not overwritten unless both the serial number and the document number match. For this reason, in the log server 33 illustrated in FIG. 14, both the log corresponding to the image forming device 32a and the log corresponding to the image forming device 32B are stored.

### Exemplary Embodiment 4

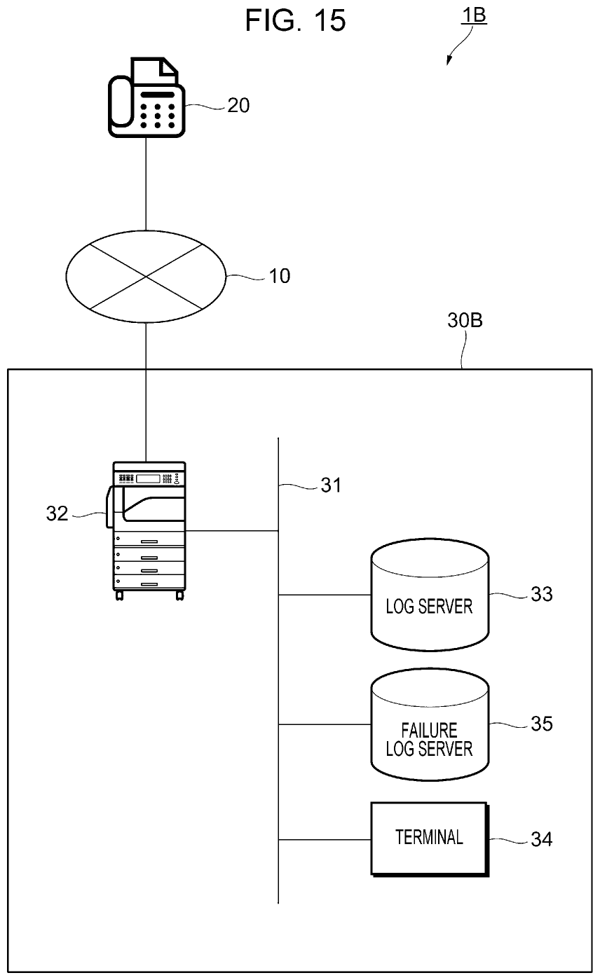

Next, Exemplary Embodiment 4 will be described. FIG. 15 is a diagram explaining a conceptual configuration of an information processing system 1B used in Exemplary Embodiment 4. In FIG. 15, portions that correspond to FIG. 1 are denoted with the same signs. Exemplary Embodiment 4 differs from Exemplary Embodiment 1 in that a failure log server 35 is added to a business system 30B. The addition of the failure log server 35 in the present exemplary embodiment is because in some cases, a history of logs indicating that facsimile transmission has failed may be required after the fact. For example, in some cases, it is desirable to know the presence or absence of failure and the number of failed attempts of a facsimile transmission before the final result of the facsimile transmission stored in the log server 33 was obtained. The failure log server 35 herein is one example of a separate area in which to retain logs stored in the log server 33. Note that the failure log server 35 is prepared separately from the log server 33 in the case of FIG. 15, but the separate area may also be managed as a different folder on the same server.

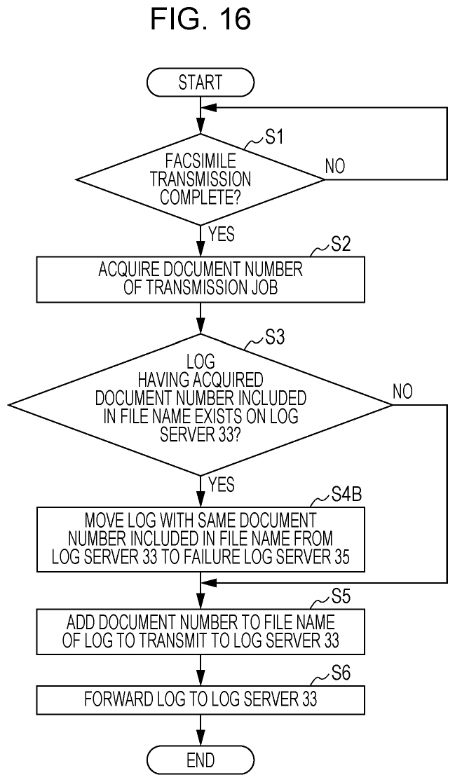

FIG. 16 is a flowchart explaining an example of processing operations according to Exemplary Embodiment 4 executed in a case of forwarding a facsimile transmission result to the log server 33. In FIG. 16, portions that correspond to FIG. 3 are denoted with the same signs. The processing operations illustrated in FIG. 16 are achieved by the system control unit 301 (see FIG. 2) executing a program. Note that the symbol “S” in the diagram means “step”. When a transmission job is launched by receiving an operation by a worker or the like, the system control unit 301 determines whether or not facsimile transmission is complete (step 1). The system control unit 301 repeats the determination while is negative result is obtained in step 1. When a positive result is obtained in step 1, the system control unit 301 acquires a document number of the transmission job (step 2).

When the document number is acquired in step 2, the system control unit 301 determines whether or not a log having the acquired document number included in the file name exists in the log server 33 (step 3). In the case in which a positive result is obtained in step 3, the system control unit 301 moves the log having the same document number included in the file name from the log server 33 to the failure log server 35 (step 4B). The reason for this is because the facsimile transmission being executed multiple times for the same transmission job means that the previous facsimile transmission(s) has failed. Consequently, in the case in which a positive result is obtained in step 3, the log stored in the log server 33 is a log indicating failure. For this reason, in the case of the present exemplary embodiment, the log stored in the log server 33 is moved to the failure log server 35 in advance.

After step 4B, or in the case in which a negative result is obtained in step 3, the system control unit 301 adds the document number to the file name of the log to transmit to the log server 33 (step 5), and after that, forwards the log to the log server 33 (step 6). At this point, the case in which a negative result is obtained in step 3 means that a log with the same document number included in the file name does not exist in the log server 33. This case corresponds to the initial facsimile transmission.

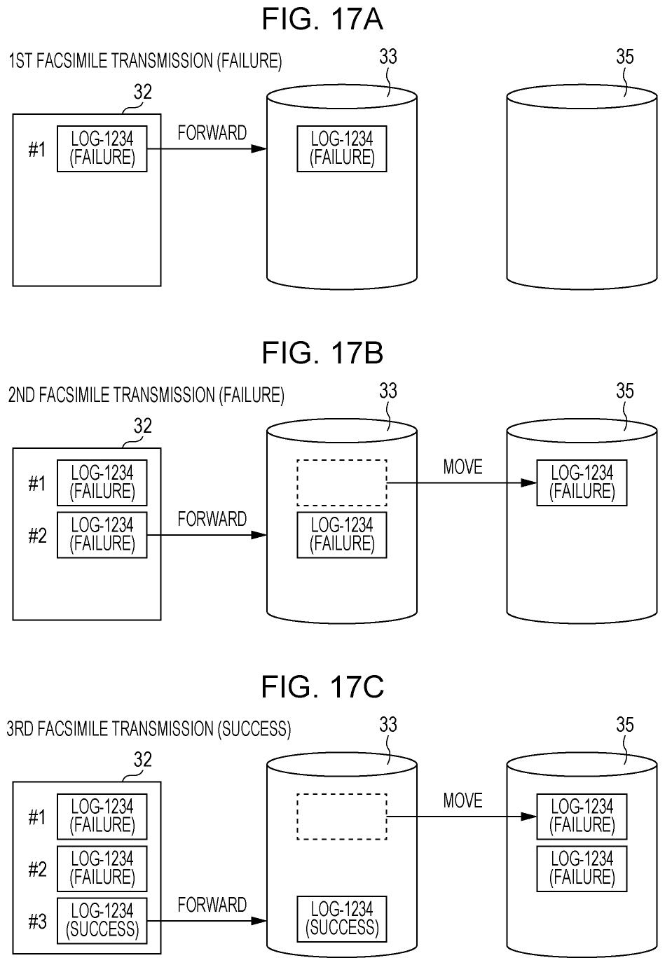

FIGS. 17A to 17C are diagrams explaining an example of log storage in Exemplary Embodiment 4, in which FIG. 17A illustrates an example of a case in which a first facsimile transmission fails, FIG. 17B illustrates an example of a case in which a second facsimile transmission fails, and FIG. 17C illustrates an example of a case in which a third facsimile transmission succeeds. Similar to the case of Exemplary Embodiment 1, in the case in which the first facsimile transmission of the document managed under the document number “1234” fails, a log whose file name includes information indicating the transmission failure is forwarded from the image forming device 32 to the log server 33 and stored.

In the case in which the first facsimile transmission fails, the transmission job of the image forming device 32 is put into a standby state. When a predetermined amount of time elapses, the image forming device 32 re-executes the transmission job. For example, the same transmission job is re-executed 30 seconds after the completion of the first facsimile transmission. Because the transmission job is the same, the document number is unchanged. In the example of FIG. 17B, the second facsimile transmission of the document managed under the document number “1234” is executed, and this second facsimile transmission also fails. In the case in which the second facsimile transmission of the same transmission job also fails, the image forming device 32 moves the log corresponding to the first facsimile transmission from the log server 33 to the failure log server 35, and after that, forwards a log corresponding to the second facsimile transmission in the log server 33. Only the most recent result of facsimile transmission for the same transmission job is stored in the log server 33, while the previous log are moved to the failure log server 35.

In the case in which the second facsimile transmission also fails, the image forming device 32 waits for a predetermined amount of time to elapse and then re-executes the same transmission job. In the example of FIG. 17C, a third facsimile transmission of the document managed under the document number “1234” is executed. In the case of FIG. 17C, the third facsimile transmission succeeds. In the case, the image forming device 32 likewise moves the log corresponding to the second facsimile transmission stored in the log server 33 to the failure log server 35, and after that, stores a log corresponding to the third facsimile transmission in the log server 33. In other words, only the most recent result of facsimile transmission for the same transmission job is stored in the log server 33, while the previous two logs are moved to the failure log server 35. For this reason, a worker or the like is able to check the final result of the facsimile transmission corresponding to each transmission job from the log information stored in the log server 33, and furthermore check a history of logs leading up to final result of the facsimile transmission corresponding to each transmission job from the log information stored in the failure log server 35.

### Other Exemplary Embodiments

The foregoing describes exemplary embodiments of the present disclosure, but the technical scope of the present disclosure is not limited to the scope described in the foregoing exemplary embodiments. It is clear from the claims that a variety of modifications or alterations to the foregoing exemplary embodiments are also included in the technical scope of the present disclosure.

For example, in the exemplary embodiments described above, the image forming device 32 (see FIG. 1) including facsimile functions and the like is illustrated as one example of a device including a function of forwarding a result of a facsimile transmission by a transmission job to the log server 33 (see FIG. 1), but the device including the functions described in the exemplary embodiments is not limited to the image forming device 32 and the like. For example, the device including the functions described in the exemplary embodiments may also be the facsimile machine 20 (see FIG. 1). The facsimile machine 20 is also one example of a transmission device.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. A transmission device comprising:
a controller configured to:
determine whether information for managing a document included in a newly generated first log is also included in a second log accumulated in the server;
when the information for managing the document included in the newly generated first log is also included in the second log, overwrite the second log with the first log; and
when the information for managing the document included in the newly generated first log is not included in the second log, cause the first log to be added and saved in the server,
wherein each log remaining in the server is only a confirmed result for each transmission job.

2.-3. (canceled)

4. The transmission device according to claim 1, wherein
when information for managing a document included in a newly generated first log is not included in a second log accumulated in the server, the controller causes the first log to be added and saved in the server.

5. The transmission device according to claim 1, wherein
the first log and the second log include information indicating an origin.

6. (canceled)

7. The transmission device according to claim 4, wherein
the first log and the second log include information indicating an origin.

8. The transmission device according to claim 1, wherein
even if a result of a transmission job is failure, the controller does not cause a log to be transmitted to the server while a possibility that retransmission will be executed remains.

9. The transmission device according to claim 8, wherein
the controller causes a log indicating failure to be transmitted to the server when there is no longer a possibility that retransmission will be executed.

10. The transmission device according to claim 8, wherein
if retransmission is successful, the controller causes a log indicating success to be transmitted to the server.

11. The transmission device according to claim 9, wherein
if retransmission is successful, the controller causes a log indicating success to be transmitted to the server.

12. The transmission device according to claim 8, wherein
the log includes information indicating an origin.

13. The transmission device according to claim 9, wherein
the log includes information indicating an origin.

14. The transmission device according to claim 1, wherein
when information for managing a document included in a newly generated first log is also included in a second log accumulated in the server, the controller causes the second log to be retained in a separate area, and after that, causes the first log to be added and saved in the server.

15. A non-transitory computer readable medium storing a program causing a computer to execute a transmission process, the process comprising:
determining whether information for managing a document included in a newly generated first log is also included in a second log accumulated in the server;
when the information for managing the document included in the newly generated first log is also included in the second log, overwriting the second log with the first log; and
when the information for managing the document included in the newly generated first log is not included in the second log, causing the first log to be added and saved in the server,
wherein each log remaining in the server is only a confirmed result for each transmission job.

16. A transmission device comprising:
controlling means for controlling:
determining whether information for managing a document included in a newly generated first log is also included in a second log accumulated in the server;
when the information for managing the document included in the newly generated first log is also included in the second log, overwriting the second log with the first log; and
when the information for managing the document included in the newly generated first log is not included in the second log, causing the first log to be added and saved in the server,
wherein each log remaining in the server is only a confirmed result for each transmission job.
